(19) United States
(12) Patent Application Publication
(10) Pub. No.: US 2026/0112234 A1
(43) Pub. Date: Apr. 23, 2026

(54) ONLINE ODDS ADJUSTMENT WITHIN MULTI-LEVEL USER STRUCTURES

(71) Applicant: KwikClick, LLC, Murray, UT (US)

(72) Inventor: Fred Cooper, Farmington, UT (US)

(21) Appl. No.: 18/133,932

(22) Filed: Apr. 12, 2023

Related U.S. Application Data
(60) Provisional application No. 63/330,197, filed on Apr. 12, 2022.

(51) Int. Cl. G07F 17/32; G06Q 50/34

(52) U.S. Cl. CPC G07F 17/323; G06Q 50/34; G07F 17/3288

(57) ABSTRACT

Systems and methods are provided for online odds adjustments within multi-wave user structures used to track online activities. Such online activities may include online wagers made at websites or web applications. Online activities may be initiated when a user device activates a coded link, which is a link in which a unique code has been embedded. The unique code may be associated with one or more upline users. The coded link may direct the user device to a specific website where different online activities may be available. Activation of the coded link may also result in automatic generation of a specific graphical user interface (GUI) associated with an online action available at the website or web application. The GUI may also be automatically populated based on the unique code and any associated information. The unique code embedded in the coded link may be used to associate such online actions with the upline users, who may be rewarded by an odds adjustment to a wager instead of, or in addition to, other rewards available in accordance with the parameters of the user structure. The odds may be adjusted yet further when the new user invites additional users to participate with a corresponding coded link.

### CROSS-REFERENCE TO RELATED APPLICATION

The present application claims the priority benefit of U.S. provisional application No. 63/330,197 filed Apr. 12, 2022, the disclosure of which is incorporated herein by reference.

### BACKGROUND OF THE INVENTION

### Field of the Invention

The present disclosure is generally related to multi-level user structures for online tracking. More specifically, the present disclosure is directed to online odds adjustments within multi-wave user structures used to track online activities.

### Description of the Related Art

Multi-level marketing (MLM) is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multi-level user structure.

Multi-level marketing is a legitimate business sales strategy. One problem is that the MLM is organized as a pyramid tree. However, pyramid “schemes” that use money from new recruits to pay people at the top rather than those who perform the work are illegal. These pyramid schemes involve taking advantage of people by pretending to be engaged in legitimate multi-level or network user structure. You can spot pyramid schemes by their greater focus on recruitment than on product sales.

One issue in determining the legitimacy of a multi-level user structure company is whether it sells its products primarily to consumers or to its members, who must recruit new members to buy their products. If it is the former, the company is likely a legitimate multi-level marketer. If it is the latter, it could be an illegal pyramid scheme.

Although each MLM company dictates its own specific financial compensation plan for the payout of any earnings to their respective participants, the common feature across all MLMs is that the compensation plans theoretically payout to participants only from two potential revenue streams. The first is paid out from commissions of sales made by the participants directly to their retail customers. The second is paid out from commissions based upon the wholesale purchases made by other distributors below the participant who have recruited those other participants into the MLM; in the organizational hierarchy of MLMs, these participants are referred to as one's downline distributors.

Therefore, MLM salespeople (distributors) are expected to sell products directly to end-user retail consumers through relationship referrals and word of mouth marketing. Still, most importantly, they are incentivized to recruit others to join the company's distribution chain as fellow salespeople to become downline distributors.

Currently, to join an MLM, there is an initiation fee, which is a barrier against those who just wish to refer a single product they like.

Current multi-level user structure (MLM) systems do not take full advantage of the internet and how consumers can influence other consumers to make purchases.

Also, current MLM systems do not incorporate incentivizing users of a multi-level user structure system by offering a dynamic commission tree.

In addition, there is no current MLM system that utilizes the money or funds dedicated to discounts or coupons to be reincorporated into a multi-level user structure system to incentivize consumers to make purchases and advertise the product they purchased.

MLMs are not designed to distribute intangible goods, such as entry into games of chance. Therefore, no MLM has a commission system wherein the commission earned is in the form of increased odds on a wager that has been placed.

### SUMMARY OF THE CLAIMED INVENTION

Embodiments of the present invention include systems and methods for online odds adjustments within multi-wave user structures used to track online activities. Such online activities may include online wagers made at websites or web applications. Online activities may be initiated when a user device activates a coded link, which is a link in which a unique code has been embedded. The unique code may be associated with one or more upline users. The coded link may direct the user device to a specific website where different online activities may be available. Activation of the coded link may also result in automatic generation of a specific graphical user interface (GUI) associated with an online action available at the website or web application. The GUI may also be automatically populated based on the unique code and any associated information. The unique code embedded in the coded link may be used to associate such online actions with the upline users, who may be rewarded by an odds adjustment to a wager instead of, or in addition to, other rewards available in accordance with the parameters of the user structure. The odds may be adjusted yet further when the new user invites additional users to participate with a corresponding coded link.

### BRIEF DESCRIPTIONS OF THE DRAWINGS

FIG. 1 illustrates a multi-level user structure system, according to an embodiment.

FIG. 2 illustrates a base module, according to an embodiment.

FIG. 3 illustrates a calculation module, according to an embodiment.

FIG. 4 illustrates a commission module, according to an embodiment.

FIG. 5 illustrates an advertising module, according to an embodiment.

FIG. 6 illustrates a vendor module, according to an embodiment.

FIG. 7 illustrates a kwikclick module, according to an embodiment.

FIG. 8 illustrates a downline module, according to an embodiment.

FIG. 9 illustrates a 3rd party base module, according to an embodiment.

FIG. 10 illustrates an admin module, according to an embodiment.

FIG. 11 illustrates a discount module, according to an embodiment.

FIG. 12 illustrates a wager invite module, according to an embodiment.

FIG. 13 illustrates a wager module, according to an embodiment.

FIG. 14 illustrates an odds adjustment module, according to an embodiment.

### DETAILED DESCRIPTION

Systems and methods are provided for online odds adjustments within multi-wave user structures used to track online activities. Such online activities may include online wagers made at websites or web applications. Online activities may be initiated when a user device activates a coded link, which is a link in which a unique code has been embedded. The unique code may be associated with one or more upline users. The coded link may direct the user device to a specific website where different online activities may be available. Activation of the coded link may also result in automatic generation of a specific graphical user interface (GUI) associated with an online action available at the website or web application. The GUI may also be automatically populated based on the unique code and any associated information. The unique code embedded in the coded link may be used to associate such online actions with the upline users, who may be rewarded by an odds adjustment to a wager instead of, or in addition to, other rewards available in accordance with the parameters of the user structure. The odds may be adjusted yet further when the new user invites additional users to participate with a corresponding coded link.

“MLM Distributor” refers to the non-salaried workforce selling the company's products or services. At the same time, the earnings of the participants are derived from a pyramid-shaped or binary compensation commission system. “MLM Distributors” can be integrated into this system or method in many elements or steps of this invention.

“Distributor Contact List or followers” refers to the recruits or followers on social media that a distributor has secured to participant in their downline. “Distributor Contact List or followers” can be integrated into this system or method in many elements or steps of this invention.

“Upline” refers to the MLM distributors that recruits work for as salespeople to sell the products or services. “Upline” can be integrated into this system or method in many elements or steps of this invention.

“Downline” refers to the recruits the MLM distributors can secure as participants in the MLM system. “Downline” can be integrated into this system or method in many elements or steps of this invention.

A “Product” refers to an article or substance that is manufactured or refined for sale. “Products” can be integrated into this system or method in many elements or steps of this invention.

A “Service” refers to a system supplying a public need such as transport, communications, or utilities such as electricity or water. For example, a “service” may be an act of dealing with a customer in a store, restaurant, or hotel by taking their orders, showing, or selling them goods. Additionally, a “Service” may be work that someone does or time that someone spends working for an organization or a business that offers a particular type of help or work. A “Service” can be integrated into this system or method in many elements or steps of this invention.

“Network Marking” refers to a business model that depends on person-to-person sales by independent representatives, often working from home. For example, a “Network User structure” business may require independent representatives to build a network of business partners or salespeople to assist with lead generation and closing sales. “Network User structure” can be integrated into this system or method in many elements or steps of this invention.

A “Commission” refers to a payment to someone who sells goods directly related to the amount sold or a system that uses such payments. A “Commission” can be integrated into this system or method in many elements or steps of this invention.

“Commission Plan” refers to the decay rate of the commissions provided to the MLM system from the discount offered by the 3rd party. The 3rd party also selects the decay rate to calculate the commissions offered to the first purchaser and the percentage offered to the downline participants. Therefore, the “Commission Plan” can be integrated into this system or method in many elements or steps of this invention.

“Commission Tree” refers to the payment structure in which commissions are given out. “Commission Tree” can be integrated into this system or method in many elements or steps of this invention.

“Advertise to the Network” refers to the advertisement provided to the MLM system from the 3rd party offering a product, good, or service. “Advertise to the Network” can be integrated into this system or method in many elements or steps of this invention.

“Advertising Link” refers to a link that directs a consumer to a product, service, or good. “Advertising Link” can be integrated into this system or method in many elements or steps of this invention.

“Social media plug-ins for enhanced user structure” refer to sharing content with other people through social media platforms, for example, a share or like button. “Social media plug-ins for enhanced user structure” can be integrated into this system or method in many elements or steps of this invention.

“Local media (video's, pictures, text, sounds/haptics, other local media (online product descriptions for enhanced user structure” refer to the various types of media, such as photos, videos, etc. “Local media (video's, pictures, text, sounds/haptics, other local media) online product descriptions for enhanced user structure” can be integrated into this system or method in many elements or steps of this invention.

“End of life of MLM tree” refers to the end of the MLM tree in which further participants in the MLM will not receive a commission, the commission tree starts up again, or the commission tree is restructured in some form. “End of life of MLM tree” can be integrated into this system or method in many elements or steps of this invention.

“Rating and recommendation modules” refer to modules in which a company, entity, or person provides ratings and/or recommendations for products, goods, or services. “Rating and recommendation modules” can be integrated into this system or method in many elements or steps of this invention.

“Existing MLM system” refer to currently existing or established companies that use the sales strategies to encourage existing distributors to recruit new distributors who are paid a percentage of their recruits' sales. “Existing MLM system” can be integrated into this system or method in many elements or steps of this invention.

“As seen on TV sales” refer to a generic nameplate for products advertised on television in the United States for direct-response mail-order through a toll-free telephone number. “As seen on TV sales” can be integrated into this system or method in many elements or steps of this invention.

A “Franchise” refers to an authorization granted by a government or company to an individual or group enabling them to carry out specified commercial activities, e.g., providing a broadcasting service or acting as an agent for a company's products. “Franchise” can be integrated into this system or method in many elements or steps of this invention.

“Product consumables” refer to goods by individuals and businesses that must be replaced regularly because they wear out or are used up. “Product consumables” can be integrated into this system or method in many elements or steps of this invention.

“Service networks” refer to a collection of people and information brought together on the internet to provide a specific service or achieve a common business objective, such as Angie's List. “Service networks” can be integrated into this system or method in many elements or steps of this invention.

“Downlines tree goes across country boundaries” refers to the ability to pay out commissions for an MLM tree even though the participants in the MLM tree may not reside in the same country. In this case, the commissions would need to be calculated for the appropriate exchange rate to ensure participants are paid in their countries' currency in the correct amount. “Downlines tree goes across country boundaries” can be integrated into this system or method in many elements or steps of this invention.

“ID Enrollment” refers to a participant enrolling in an MLM product tree through an ID unique to each participant in the MLM system, which may correspond to a unique code that can be embedded in a link to a particular website, web page, or web application. A new user (e.g., user not found in current database records) may be introduced to the current user structure when the new user selects a coded link into which a unique code associated with a set of one or more upline users has been embedded. The new user may be automatically assigned a new code, which is further associated with the set of upline users. Thus, use of an embedded link that includes the new code may be associated with the new user and their set of upline users. “ID Enrollment” can be integrated into this system or method in many elements or steps of this disclosure.

“Track profits and payments” refers to the MLM system tracking the profits of the MLM and tracking the payments or commissions paid out to participants. “Track profits and payments” can be integrated into this system or method in many elements or steps of this invention.

“Track taxes” refers to tracking the commissions provided to participants for tax purposes. “Track taxes” can be integrated into this system or method in many elements or steps of this invention.

“Communicate events with downlines and uplines” refers to advertising events to participants in an MLM system. “Communicate events with downlines and uplines” can be integrated into this system or method in many elements or steps of this invention.

“Product returns” refer to a process in which a customer or consumer takes previously purchased product, merchandise, or goods back to the retailer, and in turn, receive a refund in the original form of payment, exchange for another item (identical or different), or store credit. “Product returns” can be integrated into this system or method in many elements or steps of this invention.

“Product discounts” refer to a reduced price or something being sold at a price lower than that item is normally sold for. It is a reduction to a basic price for a good or service. “Product Discounts” can be integrated into this system or method in many elements or steps of this invention.

A “Credit card system” refers to a system that allows cardholders to borrow funds with which to pay for goods and services with the condition that the cardholders pay back the borrowed funds, plus interest, as well as any additional agreed-upon charges. A “Credit card system” can be integrated into this system or method in many elements or steps of this invention.

An “E-commerce sale” refers to sales of goods and services where the business occurs over the internet, an extranet, Electronic Data Interchange (EDI), or other online systems. Payment may or may not be made online. Business in this context is defined as an order placed by the buyer or price and terms of sale negotiated. An “E-commerce sale” can be integrated into this system or method in many elements or steps of this invention.

An “E-commerce shopping cart” refers to E-commerce software to assist visitors in making purchases online. The software calculates the order total upon checkout, including shipping and handling, taxes, and other parameters the site owner has previously set. An “E-commerce shopping cart” can be integrated into this system or method in many elements or steps of this invention.

A “Retailer” refers to a person or business that sells goods to the public in relatively small quantities for use or consumption rather than for resale. A “Retailer” can be integrated into this system or method in many elements or steps of this invention.

“Dynamic incentives and rewards for a product” refer to incentives or rewards that are continuously updated for a product. “Dynamic incentives and rewards for product” can be integrated into this system or method in many elements or steps of this invention.

“Suggestive selling” refers to a sales technique where an employee asks a customer if they would like to include an additional purchase or recommends a product that might suit the client. “Suggestive selling” can be integrated into this system or method in many elements or steps of this invention.

“Data security” refers to the process of protecting data from unauthorized access and data corruption throughout its lifecycle. “Data security” includes data encryption, tokenization, and key management practices that protect data across all applications and platforms. “Data security” can be integrated into this system or method in many elements or steps of this invention.

“Banking referral” refers to a structured flow of collecting and organizing referrals for banks. Businesses who have been unsuccessful in a credit application process with a bank will be asked for their permission to have their financial information passed to designated finance platforms that can contact the business in a regulated time frame. “Banking referral” can be integrated into this system or method in many elements or steps of this invention.

“User structure materials” refer to a means of user structure, advertising, or promotional materials developed by or for a license (or subject to licensee's approval) that promote the sale of the licensed product, including but not limited to television, radio, and online advertising, point of sale materials (e.g., posters, counter-cards), packaging advertising, print media and all audio or video media. “User structure materials” can be integrated into this system or method in many elements or steps of this invention.

A “Lottery” refers to a process or thing whose success or outcome is governed by chance. A means of raising money by selling tickets and giving prizes to the holders of the number drawn at random. A “Lottery” can be integrated into this system or method in many elements or steps of this invention.

“Freelancers” refer to a person who works as a writer, designer, performer, or the like, selling work or services by the hour, day, job, etc., rather than working on a regular salary basis for one employer. “Freelancers” can be integrated into this system or method in many elements or steps of this invention.

“MLM Algorithm” refers to the calculation performed using the compensation decay rate to calculate the commissions for downline participants. “MLM Algorithm” can be integrated into this system or method in many elements or steps of this invention.

“Large Box Stores” refer to a physically large retail establishment; usually, part of a chain of stores offers various products to its customers. The term sometimes refers, by extension, to the company that operates the store and might be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance. “Large Box Stores” can be integrated into this system or method in many elements or steps of this invention.

“Airline sky miles” refer to a loyalty program offered by airlines and/or credit cards. Typically, consumers accumulate a set amount of miles based on how much is spent on a ticket or a credit card and are also known as frequent flyer miles or travel points. “Airline sky miles” can be integrated into this system or method in many elements or steps of this invention.

“Social media aggregators” refers to a tool that allows a person to collate posts and updates from different social media feeds. It creates an organized view of social posts on a specific topic and displays user-generated content on live social walls. “Social media aggregators” can be integrated into this system or method in many elements or steps of this invention.

“Connect App Store” refers to connecting the app store to an MLM system. “Connect App Store” can be integrated into this system or method in many elements or steps of this invention.

Some embodiments of this disclosure, illustrating all its features, will now be discussed in detail. The words “comprising,” “having,” “containing,” and “including,” and other forms thereof are intended to be equivalent in meaning and be open-ended in that an item or items following any one of these words is not meant to be an exhaustive listing of such item or items or meant to be limited to only the listed item or items.

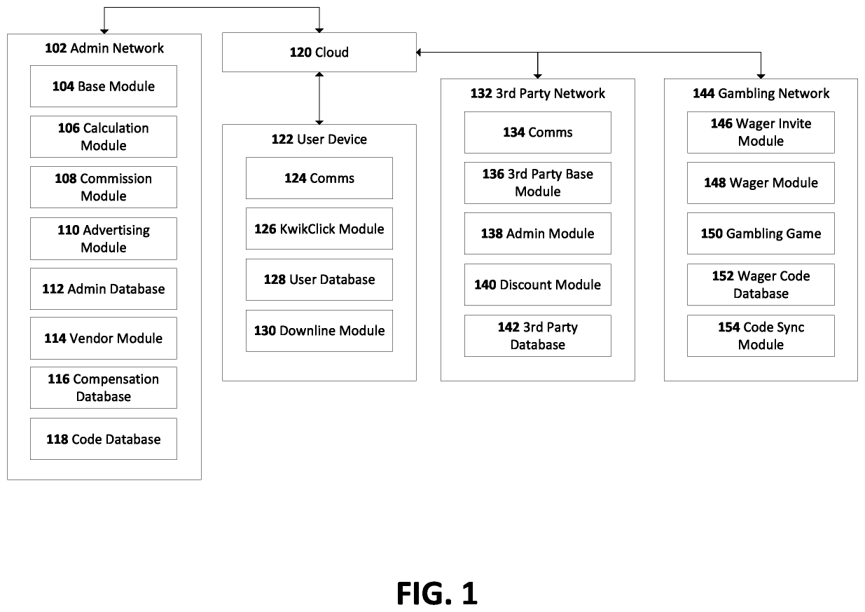

FIG. 1 is a Multi-Level User structure System. This system comprises of an Admin Network which includes a Base Module 104, Calculation Module 106, Commission Module 108, Advertising Module 110, Admin Database 112, Vendor Module 114, Compensation Database 116, and a Code Database 118, where the Admin Network is the MLM system to accept sellers (3rd parties) and where a “single product tree” multi-level user structure method is formed, comprising the steps of, providing at least one product, and providing an MLM system with a seller's commission structure, and providing at least one seller of a product with its associated commission structure, and providing a plurality of buyers/distributors, and allowing the at least one first seller to enroll an at least one product to the MLM system, and allowing at least a first buyer/distributor to purchase the at least one product, and allowing the at least the first buyer/distributor to advertise the at least one product to other potential buyers/distributors, and allowing at least a second buyer/distributor to buy the advertised product, and wherein, the seller sets a commission structure for a product, enrolls the product into the MLM system, allowing the first, second and so on purchasers/distributors to purchase and then advertise the product, and allowing the purchasers/distributors to receive a commission based upon the seller's product commission structure. In addition to or instead of the commission received from a purchase of the at least one product, a commission may be paid in the form of adjustment to the odds in a wager.

An Admin Network Base Module 104 connects to the 3rd Party Base Module 136, initiates the Vendor Module 114, and initiates the Admin Network Calculation Module 106. The 3rd Party Network Base Module 136 is the module that interacts with the sellers, and the Admin Network Vendor Module 114 is the module loaded on the seller's computers system.

An Admin Network Calculation Module 106, which is initiated by the Admin Network Base Module 104, extracts the discount received from the 3rd Party Module 136 as well as the compensation plan (e.g., its decay rate or commission structure so that each downline gets less and less commission) to determine the commissions for the MLM (Multi-Level User structure) tree and stores the data in the Admin Network Compensation Database 116.

An Admin Network Commission Module 108 is continuously polling for the user data (the user being the product purchaser/distributor) from the 3rd Party Discount Module 140. Once it receives the data, the Admin Network Commission Module 108 uses the data stored in the Admin Network Compensation Database 116 to determine the downline and upline commissions for the other users (product purchasers/distributors) within the MLM tree. It then initiates the Admin Network Advertising Module 110.

An Admin Network Advertising Module 110, which is initiated by the Admin Network Commission Module 108, determines the user's (product purchasers/distributors) sphere of influence or contact list to provide the user's potential downline purchasers/distributors with a link and a code for the potential downline purchasers/distributors to become part of the MLM tree.

An Admin Network Admin Database 112, which is created through the Admin Network Vendor Module 114 (seller of a product), contains the data received from various 3rd Parties (various sellers) that are part of the MLM, the data may contain an item ID, description of the item, the original cost of the item, the discount for the item, the cost of the item with the discount, the compensation plan decay rate and a link to the item.

An Admin Network Vendor (those selling products) Module 114, which is initiated by the Admin Network Base Module 104, receives the data from the 3rd Party Network 132, stores the data in the Admin Network Admin Database 112, creates a link for the item and sends the link back to the 3rd Party Network 132 and returns to the Admin Network Base Module 104.

An Admin Network Compensation Database 116, created through the Admin Network Calculation Module 106, contains the various commissions for the different product purchasers/distributors.

An Admin Network Code Database 118 contains the codes given to the product purchasers/distributors (users) for the product purchasers/distributors (user) to pass the code to their potential purchasers/distributors to advertise or promote the item the user has purchased.

The Cloud 120 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A User (product purchasers/distributors) Device 122 such as laptops, smartphones, tablets, computers, or smart speakers.

The User Device Comms 124 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A User Device KwikClick Module 126, which connects to the 3rd Party Network 132, allows a purchaser/distributor to select an item and the associated link, determines if the purchaser/distributor entered a code, and sends the link and code, if available, to the 3rd Party Network 132.

A User Device User Database 128 contains the users (product purchasers/distributors), followers (sphere of influence), and the follower's contact information to receive commissions on their purchases.

A User Device Downline Module 130, which is continuously polling to receive the code and link from the Admin Network Advertising Module 110, allows the purchaser/distributor to pass the code and link to the user's followers stored in the User Device User Database 128.

A 3rd Party Network 132 is the various 3rd Parties, such as retail stores, services, or e-commerce sites, that offer items to users at a discount to use MLM.

The 3rd Party Network Comms 134 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A 3rd Party Base Module 136 initiates the 3rd Party Admin Module 138, continuously polls for the user to select a link, receives the purchaser/distributor data, and initiates the 3rd Party Network Discount Module 140.

A 3rd Party Network Admin Module 138, which is initiated from the 3rd Party Network Base Module 136, connects to the Admin Network 102, sends the data for the items to be purchased, receives a link from the Admin Network 102, stores the link in the 3rd Party Network Database 142 and returns to the 3rd Party Network Base Module 136.

A 3rd Party Network Discount Module 140, which is initiated from the 3rd Party Base Module 136, extracts the link and compares it to the 3rd Party Network 3rd Party Database 142 to extract the corresponding discount for the selected item. The discount is applied to the user order. It is determined if the user entered a code or not, the order is processed, and the process returns to the 3rd Party Network Base Module 136.

A 3rd Party Network 3rd Party Database 142 contains information about the item the 3rd party selects to offer at a discount for the Admin Network 102.

A Gambling Network 144, which may be a gambling institution such as a casino, bookmaker, or any other offeror of a wager. The Gambling Network 144 may include an application or web portal which players of a gambling game can access.

A Gambling Network Wager Invite Module 146 allows a user of the Gambling Network Gambling Game 150 to invite another player to place a wager on the game. The invitation may include a discount or credit on the wager to be applied to the user who sent the invite. If the other player accepts, then the code is sent to the Gambling Network Wager Module 148. The other player may place a wager that is different from the player that made the initiation. The Gambling Network Wager Invite Module 146 may communicate with the Advertising Module 110 in identifying sphere of influence of a user.

A Gambling Network Wager Module 148 polls for when a wager has been placed, won or lost, and the amount placed, won, or lost. This data is then stored in the Gambling Network Wager Database 158. If a code was entered with the wager, it is sent to the Gambling Network Odds Adjustment Module 156.

A Gambling Network Gambling Game 150 may be any game in which a wager may be placed. The Gambling Network Gambling Game 150 may be digital, analog, or both. The Gambling Network Gambling Game 150 may be any game that would legally be considered gambling in the relevant jurisdiction.

A Gambling Network Wager Code Database 152 may contain the subset of data in the Administration Network Code Database 118 relevant to the Gambling Network and wagers.

A Gambling Network Code Sync Module 154 may poll for changes in the Administration Network Code Database 118. If the change is relevant to the Gambling Network, update the Gambling Network Wager Code Database 152.

A Gambling Network Odds Adjustment Module 156 may adjust the odds of a wager for a user as a form of commission. The odds may become more favorable to the user as other users join the wager using their code or another user's code downline.

A Gambling Network Wager Database 158 may store information on current and previous wagers. This data may include the odds given for the wager, which may be adjusted by the Gambling Network Odds Adjustment Module 156.

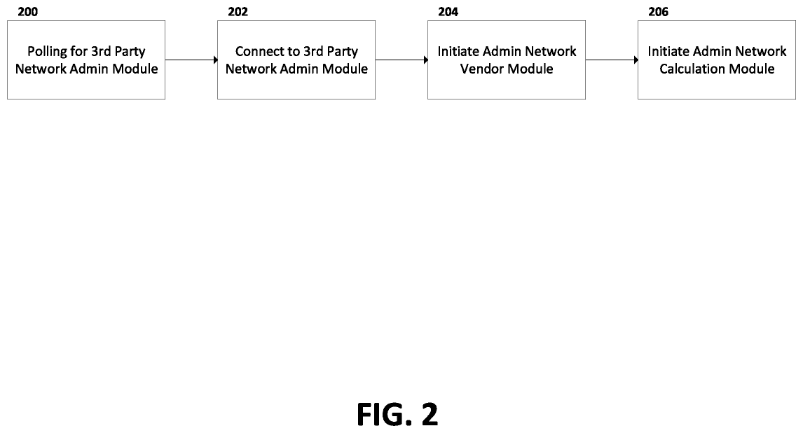

FIG. 2 displays the “Admin Network Base Module.” The process begins with the Admin Network Base Module 104 continuously polls for the 3rd Party Network Admin Module 138 (sellers of products) at step 200. The Admin Network Base Module 104 connects to the 3rd Party Network Admin Module 138 (sellers of products) at step 202. Once the Admin Network Base Module 104 connects to the 3rd Party Network Admin Module 138, the Admin Network Base Module 104 initiates the Admin Network Vendor Module 114 at step 204. Then the Admin Network Base Module 104 initiates the Admin Network Calculation Module 106, and the process returns to step 200, at step 206.

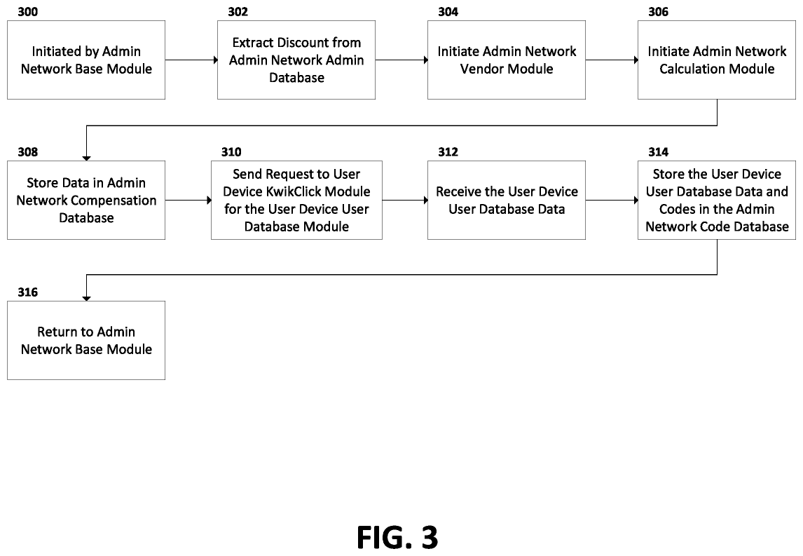

FIG. 3 displays the “Admin Network Calculation Module.” The process begins with the Admin Network Base Module 104 initiating the Admin Network Calculation Module 106 at step 300. The Admin Network Calculation Module 106 extracts the discount from the Admin Network Admin Database 112, which is received from the 3rd Party Network 132, at step 302. Then the Admin Network Calculation Module 106 extracts the compensation plan decay rate from the Admin Network Admin Database 112, at step 304. The Admin Network Calculation Module 106 determines the commissions available to the downline users or the user's followers that purchased the item. In some embodiments, the commissions may be calculated using the discount on the item and providing 50% of the discount to the first participant and the remaining discount for the downline users at a 50% decay rate. For example, if the first user purchased an item that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device KwikClick Module 126 for the data stored in the User Device User Database 128, at step 310. Then the Admin Network Calculation Module 106 receives the User Device User Database 128 data from the User Device KwikClick Module 126, at step 312. The Admin Network Calculation Module 106 stores the received data and the code data in the Admin Network Code Database 118 at step 314. The Admin Network Calculation Module 106 then returns to the Admin Network Base Module 104, at step 316.

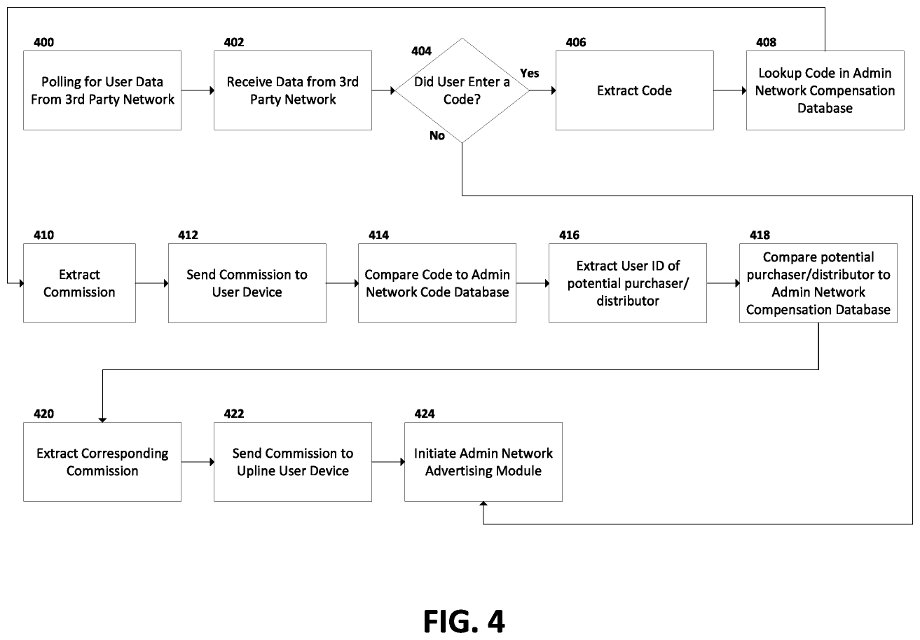

FIG. 4 displays the “Admin Network Commission Module.” The process begins with the Admin Network Commission Module 108 continuously polling for the user data from the 3rd Party Network Discount Module 140, at step 400. The Admin Network Commission Module 108 receives the user data from the 3rd Party Network Discount Module 140, at step 402. Then the Admin Network Commission Module 108 determines if the user entered a code at step 404. If the user did enter a code, the Admin Network Commission Module 108 extracts the code the user entered at step 406. The extracted code is then looked up in the Admin Network Compensation Database 116, which contains the various commissions for the different sphere of influence or potential product purchasers/distributors levels and the associated code for each of the different spheres of influence levels at step 408. Then the Admin Network Commission Module 108 extracts the corresponding commission for the code that was looked up in the Admin Network Compensation Database 116, at step 410. The Admin Network Commission Module 108 sends the commission to the user (purchaser/distributor) at step 412. Then the Admin Network Commission Module 108 compares the extracted code to the Admin Network Code Database 118, which contains the list of users and the code sent to the user's followers, at step 414. The Admin Network Commission Module 108 extracts the user ID and sphere of influence or potential purchaser/distributor using the extracted code at step 416. Then the Admin Network Commission Module 108 compares the extracted sphere of influence or potential purchaser/distributor to the Admin Network Compensation Database 116, at step 418. The Admin Network Commission Module 108 uses the extracted sphere of influence to extract the corresponding commission from the Admin Network Compensation Database 116, at step 420. The Admin Network Commission Module 108 sends the commission to the upline user at step 422. If the user did not enter a code, the Admin Network Commission Module 108 initiates the Admin Network Advertising Module 110, at step 424.

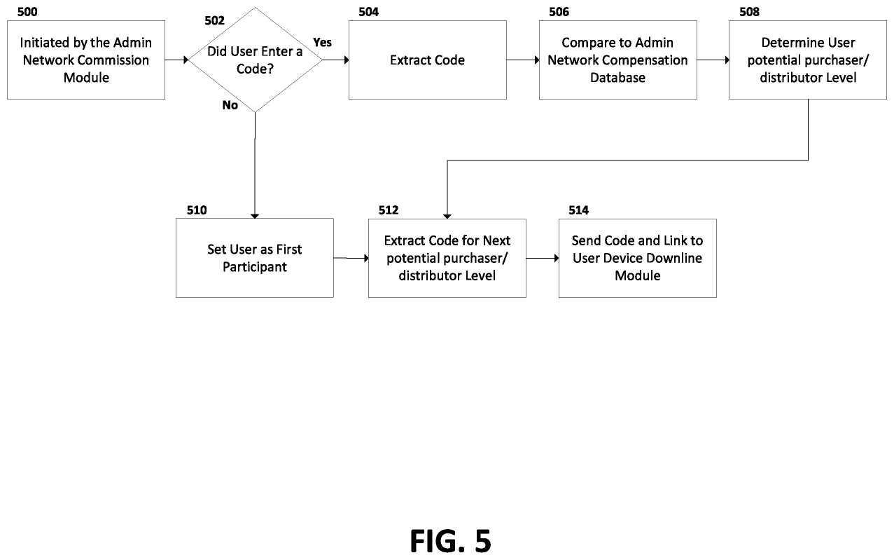

FIG. 5 displays the “Admin Network Advertising Module.” The process begins with the Admin Network Commission Module 108, initiating the Admin Network Advertising Module 110 at step 500. The Admin Network Advertising Module 110 determines if the user entered a code at step 502. If it is determined that the user entered a code, the code is extracted at step 504. The Admin Network Advertising Module 110 compares the extracted code to the Admin Network Compensation Database 116, at step 506. The Admin Network Advertising Module 110 determines the user's sphere of influence level at step 508. If it is determined that the user did not enter a code, then the Admin Network Advertising Module 110 sets the user as the “First Participant” at step 510. Then the Admin Network Advertising Module 110 extracts the code for the next sphere of influence level or potential purchaser/distributor to provide the user's followers with a code that would allow them to join the Multi-Level User structure tree, at step 512. The Admin Network Advertising Module 110 sends code and the link to the item to the User Device Downline Module 130, at step 514.

Table 1 displays the Admin Network Admin Database 112, which is created through the Admin Network Vendor Module 114. The Admin Network Vendor Module 114 receives the item data from the 3rd Party Network, creates a link for the item, stores the data in the Admin Network Admin Database 112, and sends the created link back to the 3rd Party Network. The Admin Network Admin Database 112 contains the data collected from various 3rd Parties enrolled in the Multi-Level User structure System. The Admin Network Admin Database 112 contains the name of the 3rd party, the ID for the item, a description of the item, the original cost of the item, the discount provided by the 3rd party, the cost of the item with the discount, the compensation decay rate or how the downline commissions are calculated, and the link to the item.

TABLE 1
Admin Database

| | | | Original | | Discount | Compensation | |
|---|---|---|---|---|---|---|---|
| 3rd Party | Id | Item | Cost | Discount | Cost | Decay Rate | Link |
| Home Depot | 654123 | Drill | $59.00 | 15% | $50.15 | 50% | HDDrill654123 |
| Home Depot | 789654 | Table Saw | $119.00 | 10% | $107.10 | 50% | HDTSaw789654 |
| Furniture Store | 123789 | Couch | $999.00 | 10% | $899.10 | 30% | FSC123789 |
| Pharmacy | 456812 | Cold | $25.00 | 5% | $23.75 | 50% | PCM456812 |
| | | Medicine | | | | | |
| — | — | — | — | — | — | — | — |
| — | — | — | — | — | — | — | — |
| — | — | — | — | — | — | — | — |

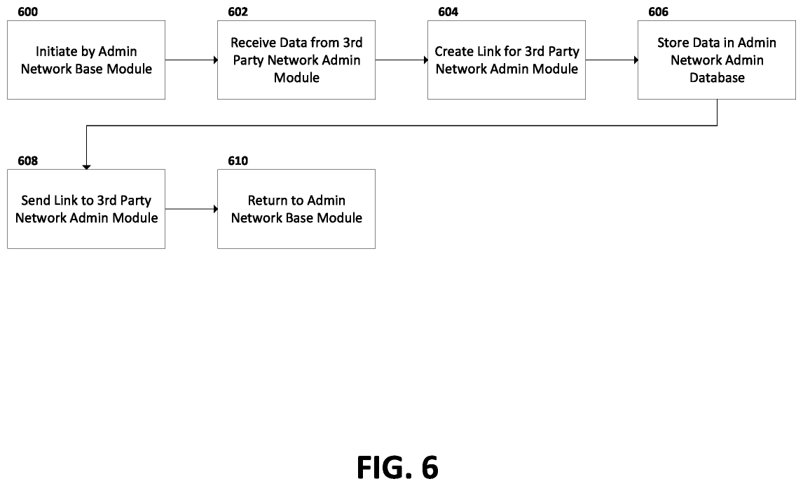

FIG. 6 displays the “Admin Network Vendor Module.” The process begins with the Admin Network Base Module 104 initiating the Admin Network Vendor Module 114 at step 600. The Admin Network Vendor Module 114 receives the data from the 3rd Party Network Admin Module 138, which may include the item to be enrolled in the MLM system, the original cost of the item, the discount provided by the 3rd party, the cost of the item with the discount, the compensation plan decay rate, etc., at step 602. Then the Admin Network Vendor Module 114 creates a link for the item for the 3rd Party Network Admin Module 138. A vendor is a seller of a product, such as a retailer, at step 604. The Admin Network Vendor Module 114 stores the received data and the created link in the Admin Network Admin Database 112, at step 606. The Admin Network Vendor Module 114 sends the link to the 3rd Party Network Admin Module 138, at step 608. The Admin Network Vendor Module 114 returns to the Admin Network Base Module 104 at step 610.

Table 2 displays the Admin Network Compensation Database 116, which is created through the Admin Network Calculation Module 106. The Admin Network Calculation Module 106 extracts the discount and the compensation plan decay rate to calculate the downline commissions for additional users. The various sphere of influence levels is stored in the Admin Network Compensation Database 116. The Admin Network Compensation Database 116 contains the 3rd party, the ID for the item, the item, the compensation plan decay rate, the various sphere of influence levels, the commission for each sphere of influence level, and the code to be used by the user's followers to enroll in the MLM system.

TABLE 2
Compensation Database

| | | | Compensation | Sphere of | | |
|---|---|---|---|---|---|---|
| Party | ID | Item | Decay Rate | Influence Level | Commission | Code |
| Home Depot | 654123 | Drill | 50% | First Participant | $3.31 | N/A |
| Home Depot | 654123 | Drill | 50% | 2 | $1.66 | 654123-SOI2 |
| Home Depot | 654123 | Drill | 50% | 3 | $0.83 | 654123-SOI3 |
| Home Depot | 654123 | Drill | 50% | 4 | $0.41 | 654123-SOI4 |
| — | — | — | — | — | — | — |

Table 3 displays the Admin Network Code Database 118 used to determine the sphere of influence of the purchaser/distributor from the code used when a purchaser/distributor purchased a product or item from a 3rd Party. The Admin Network Code Database 118 contains a User ID, ID, Item, Sphere of Influence/potential purchaser/distributor, and code for followers.

TABLE 3
Code Database

| | | | Sphere of Influence/ | |
|---|---|---|---|---|
| | | | potential | Code for |
| User ID | ID | Item | purchaser/distributor | Followers |
| JS1234 | 654123 | Drill | First Participant | 654123-SOI2 |
| HY8569 | 654123 | Drill | 2 | 654123-SOI3 |
| JS1234 | 223344 | Wager on Horse | First Participant | 223344-SOI1 |
| | | #1 to Win | | |
| | | (Race Jun. 28, 2021) | | |
| MB4985 | 223344 | Wager on Horse | 2 | 223344-SOI2 |
| | | #1 to Win | | |
| | | (Race Jun. 28, 2021) | | |
| — | — | — | — | — |
| — | — | — | — | — |

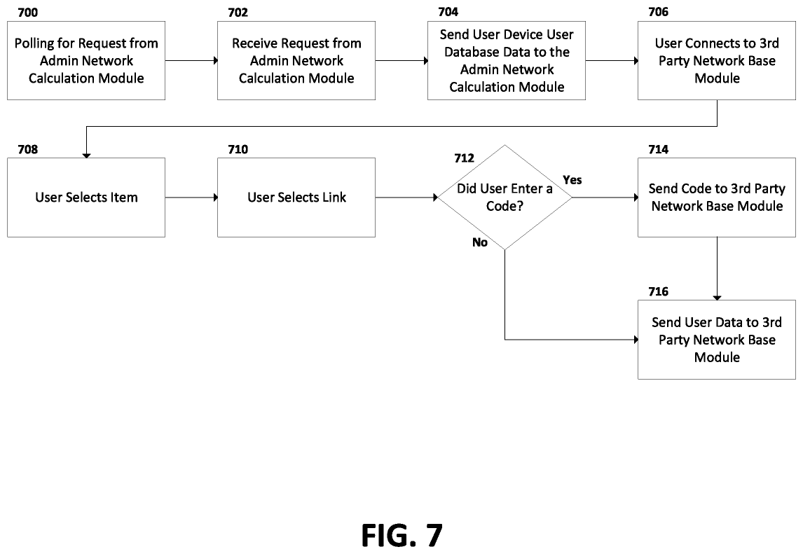

FIG. 7 displays the “User Device KwikClick Module.” The process begins with the User Device KwikClick Module 126 continuously polling for a request from the Admin Network Calculation Module 106 for the User Device User Database 128 data, at step 700. The User Device KwikClick Module 126 receives a request from the Admin Network Calculation Module 106 for the User Device User Database 128 data, at step 702. Then the User Device KwikClick Module 126 sends the User Device User Database 128 data to the Admin Network Calculation Module 106, at step 704. The User Device KwikClick Module 126 connects to the 3rd Party Network Base Module 136, at step 706. Then the user selects an item from the 3rd Party Network 132, at step 708. The user selects the link from the 3rd Party Network 132, at step 710. Then the User Device KwikClick Module 126 determines if the user entered a code; if not, the process continues to step 710, at step 712. If the user entered a code, the User Device KwikClick Module 126 sends the code to the 3rd Party Network Base Module 136, at step 714. The User Device KwikClick Module 126 sends the user data to the 3rd Party Network Base Module 136. In some embodiments, the user data may be data to purchase the item such as name, address, billing information, etc., at step 716.

Table 4 displays the User Device User Database 128, which contains the user's followers and the follower's information. The User Device User Database 128 contains the user's ID, the follower's user ID, the code provided to the followers, the follower's e-mail address, the follower's phone number, the follower's address. In some embodiments, the User Device User Database 128 may contain the follower's social media information such as Twitter, Instagram, Facebook, etc. In some embodiments, the User Device User Database 128 may contain payment information such as bank accounts, credit card information, PayPal, Venmo, etc.

TABLE 4
User Database

| User | Follower | | | | |
|---|---|---|---|---|---|
| ID | ID | Code for Followers | Follower E-mail | Follower Phone | Follower Address |
| JS1234 | HY8569 | 654123-SOI2 | HY8569@gmail.com | 781-654-8972 | 123 Main Street, |
| | | | | | Boston, MA |
| JS1234 | IT8527 | 654123-SOI2 | IT8527@yahoo.com | 231-456-7891 | 58 Elm Street, |
| | | | | | Burlington, VT |
| JS1234 | RW4569 | 654123-SOI2 | RW4569@gmail.com | 654-987-3217 | 96 2nd Ave, |
| | | | | | Salt Lake City, UT |
| — | — | — | — | — | — |
| — | — | — | — | — | — |
| — | — | — | — | — | — |

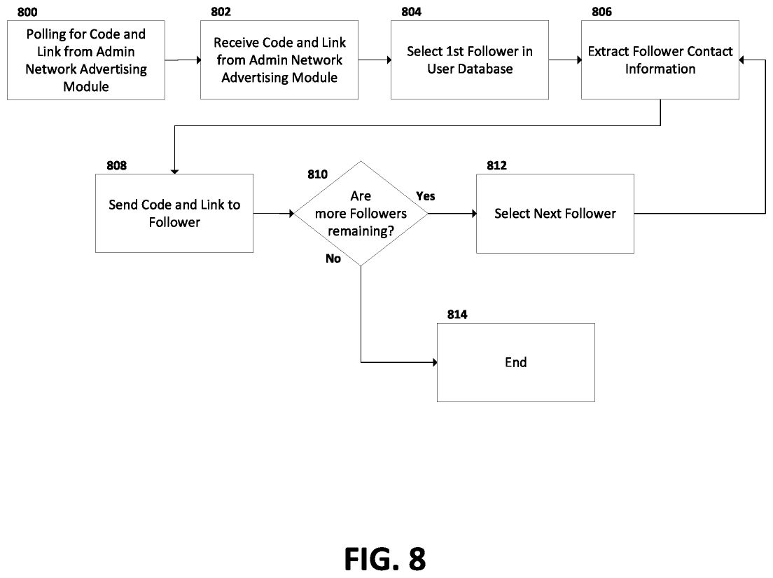

FIG. 8 displays the “User Device Downline Module.” The process begins with the User Device Downline Module 130 continuously polling for the code and the link from the Admin Network Advertising Module 110, at step 800. The User Device Downline Module 130 receives the code and the link from the Admin Network Advertising Module 110, at step 802. The User Device Downline Module 130 selects the first follower in the User Device User Database 128 at step 804. The User Device Downline Module 130 extracts the follower's contact information stored in the User Device User Database 128 at step 806. Then the User Device Downline Module 130 sends the code and link to the follower's contact information. In some embodiments, the code and link may be shared on social media sites, such as Twitter, Instagram, Facebook, etc., for the user's followers to receive the code and link at step 808. The User Device Downline Module 130 determines if more followers remain in the User Device User Database 128 at step 810. If it is determined that more followers are stored in the User Device User Database, the User Device Downline Module 130 selects the next user stored in the User Device User Database 128, and the process returns to step 806 at step 812. If the User Device Downline Module 130 determines that there are no more followers remaining in the User Device User Database 128, then the process ends at step 814.

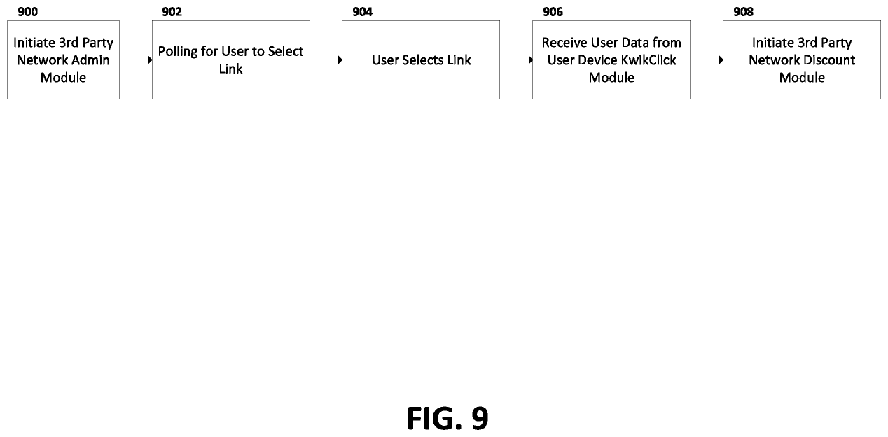

FIG. 9 displays the “3rd Party Network 3rd Party Base Module”. The process begins with the 3rd Party Network Base Module 136 initiating the 3rd Party Network Admin Module 138, at step 900. Then the 3rd Party Network Base Module 136 continuously polls for the user to select the link at step 902. The user selects the link on the 3rd Party Network 132, at step 904. Then the 3rd Party Network Base Module 136 receives the user data from the User Device KwikClick Module 126. In some embodiments, the user data may be data to purchase the item such as name, address, billing information, etc., at step 906. Then the 3rd Party Network Base Module 136 initiates the 3rd Party Network Discount Module 140, at step 908.

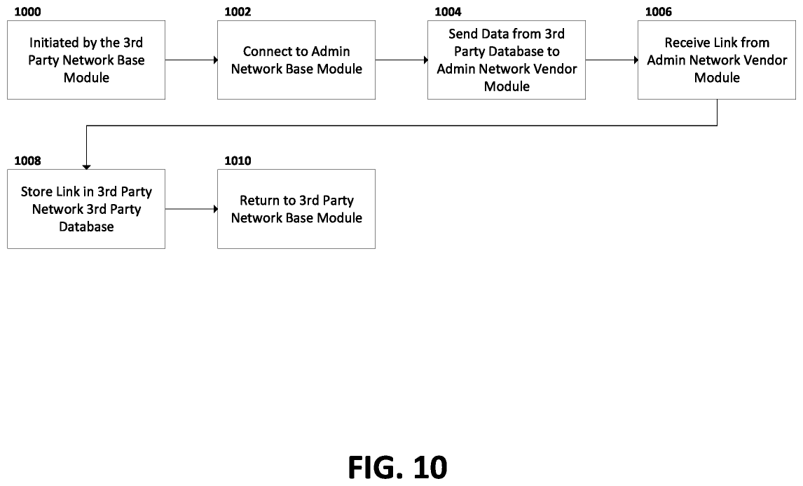

FIG. 10 displays the “3rd Party Network Admin Module”. The process begins with the 3rd Party Network Admin Module 138 being initiated by the 3rd Party Network Base Module 136, at step 1000. The 3rd Party Network Admin Module 138 connects to the Admin Network 102 at step 1002. Then the 3rd Party Network Admin Module 138 sends the 3rd Party Network 3rd Party Database 142 to the Admin Network Vendor Module 114, at step 1004. The 3rd Party Network Admin Module 138 receives the link for the item from the Admin Network Vendor Module 114 at step 1006. Then the 3rd Party Network Admin Module 138 stores the link in the 3rd Party Network 3rd Party Database 142, at step 1008. Then the 3rd Party Network Admin Module 138 returns to the 3rd Party Network Base Module 136, at step 1010.

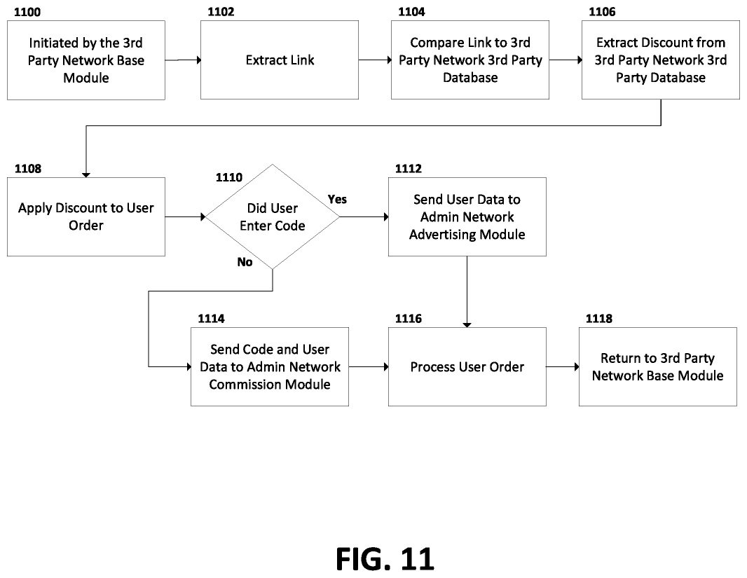

FIG. 11 displays the “3rd Party Network Discount Module”. The process begins with the 3rd Party Network Base Module 136 initiating the 3rd Party Network Discount Module 140, at step 1100. The 3rd Party Network Discount Module 140 extracts the link received from the user through the process described in the 3rd Party Network Base Module 136, at step 1102. Then the 3rd Party Network Discount Module 140 compares the extracted link to the 3rd Party Network 3rd Party Database 142, at step 1104. The 3rd Party Network Discount Module 140 extracts the corresponding discount using the extracted link from the 3rd Party Network 3rd Party Database 142, at step 1106. Then the 3rd Party Network Discount Module 140 applies the extracted discount to the user's order at step 1108. The 3rd Party Network Discount Module 140 determines if the user entered a code at step 1110. If it is determined that the user did not enter a code, the 3rd Party Network Discount Module 140 sends the user data to the Admin Network Advertising Module 110, at step 1112. If it is determined that the user entered a code, the 3rd Party Network Discount Module 140 sends the code and the user data to the Admin Network Commission Module 108, at step 1114. Then the 3rd Party Network Discount Module 140 processes the user's order at step 1116. Then the 3rd Party Network Discount Module 140 returns to the 3rd Party Network Base Module 136, at step 1118.

Table 5 displays the 3rd Party Network 3rd Party Database 142, which contains the information about the items enrolled in the MLM system and the link created by the Admin Network Vendor Module 114. The 3rd Party Network 3rd Party Database 142 contains the item ID, the item, the original cost of the item, the discount provided by the 3rd party for the item, the cost of the item with the discount, the compensation plan decay rate which the 3rd party enters, and the link received from the Admin Network Vendor Module 114.

TABLE 5
3rd Party Database

| | | Original | | Discount | Compensation | |
|---|---|---|---|---|---|---|
| ID | Item | Cost | Discount | Cost | Decay Rate | Link |
| 654123 | Drill | $59.00 | 15% | $50.15 | 50% | HDDrill654123 |
| — | — | — | — | — | — | — |
| — | — | — | — | — | — | — |
| — | — | — | — | — | — | — |

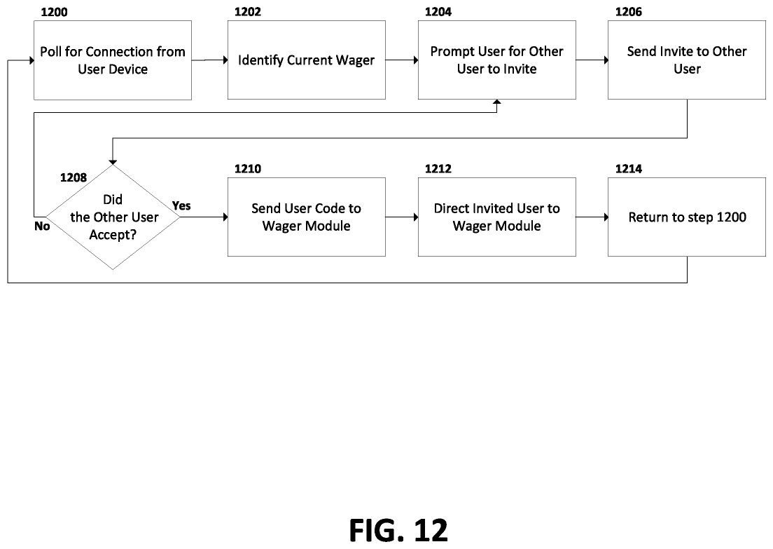

FIG. 12 displays the “Gambling Network Wager Invite Module.” The process may begin with the Gambling Network Wager Invite Module 146 polling for connection from the User Device 122. This connection may be initiated through a web browser or an application on the User Device 122. The connection may be initiated through an interface that includes an “invite friend” button or similar element at step 1200. The connection may be initiated through a user interaction with a link to a product that may be shared on social media sites. The Gambling Network Wager Invite Module 146 may identify the current wager. Data on the current wager may be available if the wager is made digitally. If the wager is analog, the user or another person, such as a dealer, may need to identify the wager manually. An analog wager may also be identified by an algorithm that receives data from sensors. For example, if the wager is on a blackjack game, the wager is identified as a blackjack wager. The wager may be further identified by which table the wager is made at, the time of the wager, the sequence of the wager, certain wager amounts, etc., at step 1202. The Gambling Network Wager Invite Module 146 may prompt the user for another user to send an invite. The user may enter the other user's contact information such as a phone number, user ID, or an ID recognized by the Gambling Network 144. The user may identify the User Device 122 of the other user via wireless communication such as NFC, Wi-Fi, or Bluetooth using their own User Device 122, at step 1204. The Gambling Network Wager Invite Module 146 may send an invite to the other user. The invite may include details on the bet and the inviting user. The invite may include GUI elements that allow the other user to accept or decline at step 1206. The Gambling Network Wager Invite Module 146 may determine if the other user accepted the initiation to make a wager. If the other user did not accept, the Gambling Network Invite Module 146 may return to step 1204 and inform the user that the invite was declined at step 1208. If the invite was accepted, the Gambling Network Wager Invite Module 146 may send the code associated with the wager and the inviting user to the Gambling Network Wager Module 148. In another embodiment, the code is associated with the user who sent the invite. In another embodiment, the code is automatically retrieved by the interaction with a link associated with a product indicative of a purchase of the product by the other user. The code may be retrieved from the User Device, the Wager Code Database 152, or another database such as the Administration Network Code Database 118, at step 1210. The Gambling Network Wager Invite Module 146 may direct the invited user to the Gambling Network Wager Module 148 to place a wager at step 1212. The Gambling Network Wager Invite Module 146 may return to step 1200, at step 1214.

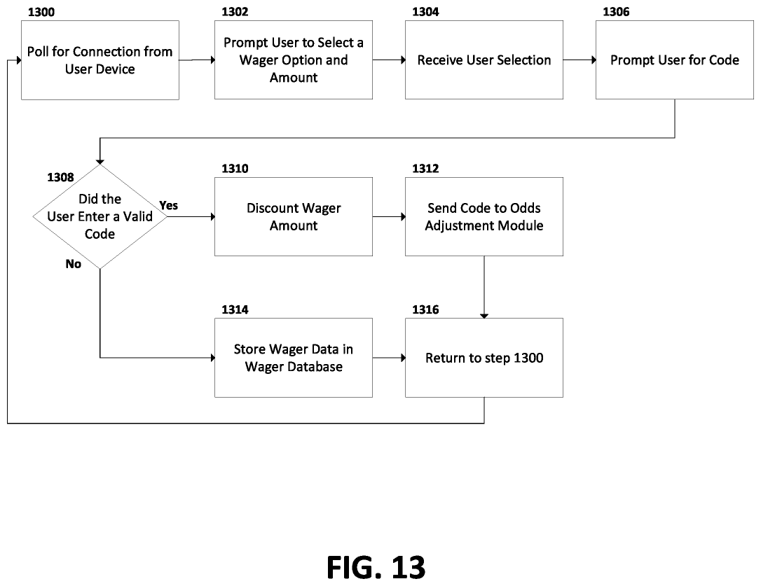

FIG. 13 displays the “Gambling Network Wager Module.” The process may begin with the Gambling Network Wager Module 148 polling for connection from the User Device 122. This connection may be initiated through a web browser or an application on the User Device 122. The connection may be initiated through an interface with a “Wager” button or a similar element. The connection might be directed from the Gambling Network Wager Invite Module 146 if the user accepted an invite at step 1300. The Gambling Network Wager Module 148 may prompt the user to select a wager option and amount. Wager options may be numbers on a roulette wheel or which sports team the user thinks will win a game. Wager amount is the amount of money, chips, credits, or other value that the user is wagering at step 1302. The Gambling Network Wager Module 148 may receive the wager option and amount selected by the user. If the Gambling Network Gambling Game 150 is analog, this data may be retrieved from sensors or manually entered by the user or another person, such as a dealer at step 1304. The Gambling Network Wager Module 148 may prompt the user to enter a code. If the user was directed from the Gambling Network Wager Invite Module 146, the code might automatically be entered. If the Gambling Network Gambling Game 150 is analog, then the code may be retrieved from a scanner or manually entered by the user or another person, such as a dealer at step 1306. The Gambling Network Wager Module 148 may determine if the user entered a code. Then, the Gambling Network Wager Module 148 will search the Gambling Network Wager Code Database 152 for the code. If the code is in the database, then it may be determined to be valid. If the user did not enter a code or the code entered was invalid, the Gambling Network Wager Module 148 may skip to step 1314, at step 1308. If the user entered a valid code, The Gambling Network Wager Module 148 might discount the wager. For example, the user may wager $20 on the next spin of a roulette wheel but may only need to spend $10 at step 1310. The Gambling Network Wager Module 148 may send the code to the Gambling Network Odds Adjustment Module 156. Odds adjustment may be fixed or may be based on the amount wagered. If based on the amount wagered, the Gambling Network Wager Module 148 will also send the amount wagered at step 1312. The Gambling Network Wager Module 148 may store the wager data in the Gambling Network Wager Database 158. Wager data may include the wager ID for the selected wager option, the user ID of the user, the amount wagered, and the odds offered to the user. The odds offered may be fixed or may be different for each user at step 1314. The Gambling Network Wager Module 148 may return to step 1300, at step 1316.

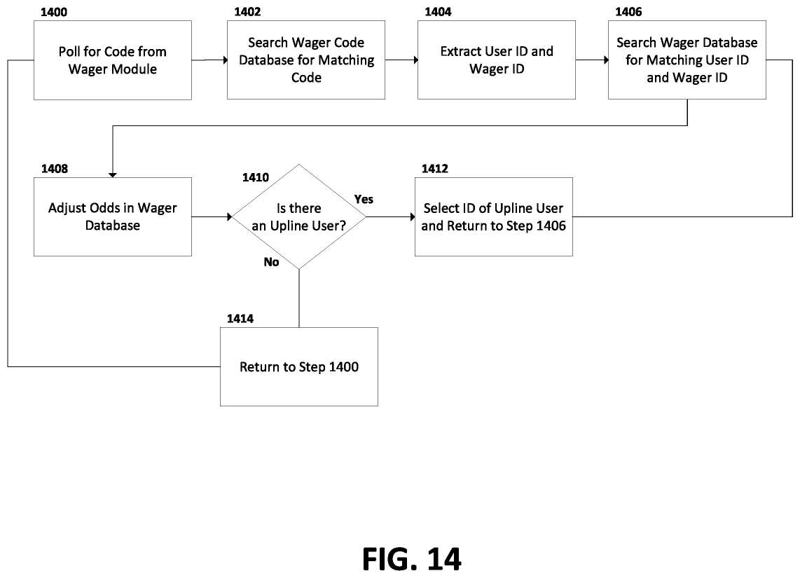

FIG. 14 displays the “Gambling Network Odds Adjustment Module.” The process may begin with the Gambling Network Odds Adjustment Module 156 polling for a code from the Gambling Network Wager Module 148, at step 1400. The Gambling Network Odds Adjustment Module 156 may search the Gambling Network Wager Code Database 152 for a matching code at step 1402. The Gambling Network Odds Adjustment Module 156 may extract the user ID and wager ID from the entry with the matching code at step 1404. The Gambling Network Odds Adjustment Module 156 may search the Gambling Network Wager Database 158 for a matching user ID and wager ID at step 1406. The Gambling Network Odds Adjustment Module 156 may adjust the odds of the entry with the matching user ID and wager ID. Odds adjustment may be based on several factors such as the amount wagered by the user who used the code, the amount wagered by the user whose odds are being adjusted, a maximum odds adjustment allowed, the degrees of separation between the user making a wager and the user who's odds are being adjusted, the risk involved to the Gambling Network 144 or any other factor which may be relevant to incentivizing wagering or preventing exploitation of the commission model by users, at step 1408. In an embodiment, the degrees of separation between the users may be determined by identifying a sphere of influence of the user. The Gambling Network Odds Adjustment Module 156 may determine if there is an upline user. This user might be the user that provided a code to the user who had their wager odds adjusted in step 1408, at step 1410. If there is an upline user, the Gambling Network Odds Adjustment Module 156 may select the user ID of the upline user and return to step 1406. The same wager ID may be used at step 1412. If there is no upline user, the Gambling Network Odds Adjustment Module 156 may return to step 1400, at step 1414.

Table 6 displays the “Gambling Network Wager Database.” The Gambling Network Wager Database 158 may contain information on current and previous wagers. The Gambling Network Wager Database 158 may contain an ID for the wager, which may be the same ID as the product ID of the wager on the Administration Network 102. The Gambling Network Wager Database 158 may contain a user ID of a user who placed a wager and the amount wagered by that user. The Gambling Network Wager Database 158 may contain odds for the wager, which may be adjusted.

TABLE 6
Wager Database

| Wager ID | User ID | Wager Ammount | Odds |
|---|---|---|---|
| 223344 | JS1234 | $100 | 1 to 3.14159 |
| 223344 | MB4985 | $15 | 1 to 3 |
| — | — | — | — |
| — | — | — | — |

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for code-based tracking of online wager actions, the method comprising:
storing a first code in a database in memory, wherein the first code is associated with a first user of a multi-line user structure;
receiving a request sent over a communication network from a user device of a second user using an online web application associated with a link having the first code embedded therein, wherein the request includes one or more selected wager options for an virtual game hosted by the online web application, and wherein the virtual game is associated with one or more set of odds related to different wager options;
identifying the multi-line user structure associated with the request based on the first code in the database matching the first code embedded in the link;
adjusting a set of odds associated with one or more wager options selected by the first user during play of the virtual game based on the identified multi-line user structure.

2. The method of claim 1, further comprising retrieving information associated with the first code in response to an interaction with the link by the user device of the second user.

3. The method of claim 1, wherein the link having the first code embedded is encoded in an image scanned by a scanner.

4. The method of claim 1, further comprising identifying the set of odds further based on stored information associated with the first user, wherein different users are assigned a different set of odds.

5. The method of claim 1, wherein adjusting the set of odds is further based on an identified threshold maximum adjustment value.

6. The method of claim 1, wherein adjusting the odds is further based on the wager options selected by the first user device.

7. The method of claim 1, wherein adjusting the odds is further based on wager options selected by the second user device.

8. The method of claim 1, wherein adjusting the odds is further based on a degree of separation between the first user and the second user.

9. The method of claim 8, wherein the degree of separation is determined from a sphere of influence of the first user.

10. The method of claim 1, further comprising generating one or more invites to be transmitted over the communication network to user devices of one or more invitees to join the virtual game, the invites including the link having the first code embedded, wherein adjusting the odds is further based on a number of the invitees that activated the link.

11. A system for code-based tracking of online wager actions, the system comprising:
memory that stores a first code in a database, wherein the first code is associated with a first user of a multi-line user structure;
a communication interface that communicates over a communication network to receive a request from a user device of a second user using an online web application associated with a link having the first code embedded therein, wherein the request includes one or more selected wager options for an virtual game hosted by the online web application, and wherein the virtual game is associated with one or more set of odds related to different wager options; and
a processor that executes instructions stored in memory, wherein the processor executes the instructions to:
identify the multi-line user structure associated with the request based on the first code in the database matching the first code embedded in the link;
adjust a set of odds associated with one or more wager options selected by the first user during play of the virtual game based on the identified multi-line user structure.

12. The system of claim 11, wherein the processor executes further instructions to retrieving information associated with the first code in response to an interaction with the link by the user device of the second user.

13. The system of claim 11, wherein the link having the first code embedded is encoded in an image scanned by a scanner.

14. The system of claim 11, wherein the processor executes further instructions to identify the set of odds further based on stored information associated with the first user, wherein different users are assigned a different set of odds.

15. The system of claim 11, wherein the processor adjusts the odds further based on an identified threshold maximum adjustment value.

16. The system of claim 11, wherein the processor adjusts the odds further based on the wager options selected by the first user device.

17. The system of claim 11, wherein the processor adjusts the odds further based on the wager options selected by the second user device.

18. The system of claim 11, wherein the processor adjusts the odds further based on a degree of separation between the first user and a second user, wherein the degree of separation is determined from a sphere of influence of the first user.

19. The system of claim 11, wherein the processor executes further instructions to generate one or more invites to be transmitted over the communication network to user devices of one or more invitees to join the virtual game, the invites including the link having the first code embedded, wherein the processor adjusts the odds further based on a number of the invitees that activated the link.

20. A non-transitory computer-readable storage medium, having embodied thereon instructions executable by a computing system to perform a method for code-based tracking of online wager actions, the method comprising:
storing a first code in a database in memory, wherein the first code is associated with a first user of a multi-line user structure;
receiving a request sent over a communication network from a user device of a second user using an online web application associated with a link having the first code embedded therein, wherein the request includes one or more selected wager options for an virtual game hosted by the online web application, and wherein the virtual game is associated with one or more set of odds related to different wager options;
identifying the multi-line user structure associated with the request based on the first code in the database matching the first code embedded in the link;
adjusting a set of odds associated with one or more wager options selected by the first user during play of the virtual game based on the identified multi-line user structure.
